(19) United States
(12) Patent Application Publication
(10) Pub. No.: US 2014/0210804 A1
(43) Pub. Date: Jul. 31, 2014

(54) METHOD OF DYNAMIC CHARGE SHARING FOR A DISPLAY DEVICE

(71) Applicant: HIMAX TECHNOLOGIES LIMITED, Tainan City (TW)

(72) Inventors: Huan-Sen Liao, Tainan City (TW); Jen Chun Peng, Tainan City (TW)

(73) Assignee: HIMAX TECHNOLOGIES LIMITED, Tainan City (TW)

(21) Appl. No.: 13/751,141

(22) Filed: Jan. 27, 2013

(51) Int. Cl. G09G 3/36

(52) U.S. Cl. CPC G09G 3/3614
USPC 345/209; 345/96

(57) ABSTRACT

In a method of dynamic charge sharing for a display device, it is determined whether a current line of a data driver has polarity inverted from a preceding line. Charge sharing is performed globally, if it is determined that the current line is polarity inverted from the preceding line. It is further determined whether the current line and the preceding line are substantially different, if it is determined that the current line is not polarity inverted from the preceding line. Charge sharing is performed in groups if it is determined that the current line and the preceding line are substantially different; otherwise, no charge sharing is performed.

### BACKGROUND OF THE INVENTION

1. Field of the Invention

The present invention generally relates to charge sharing, and more particularly to a method of dynamic charge sharing for a liquid crystal display (LCD) panel.

2. Description of Related Art

As a resolution of a liquid crystal display (LCD) becomes higher and a panel size of the LCD larger, drivers adopted in the LCD consume more power. Moreover, alternating-current (AC) current consumption in the LCD may be substantively affected by capacitive loading. Charge sharing is therefore proposed to electrically short among channels of a source driver in order to obtain an averaged output level before required output levels of pixel data are finally generated. Accordingly, some power may be conserved by performing the charge sharing.

The charge sharing adopted in the LCD panel is performed globally. That is, all channels are subject to charge sharing. Nevertheless, with respect to some pixel patterns, performing charge sharing incurs more power consumption, instead of saving power. Moreover, with respect to those pixel patterns, power consumption still increases even no charge sharing is performed.

A need has thus arisen to propose a novel method for effectively performing charge sharing.

### SUMMARY OF THE INVENTION

In view of the foregoing, it is an object of the embodiment of the present invention to provide a method of dynamic charge sharing for dynamically determining either performing charge sharing globally or in groups, or performing no charge sharing, therefore greatly reducing power consumption.

According to one embodiment, a method of dynamic charge sharing for a display device performs the following steps. It is determined whether pixel data corresponding to a current line to be outputted from channels of a data driver have polarity inverted from a preceding line outputted from the channels. Charge sharing is performed globally for all the channels, if it is determined that the current line is polarity inverted from the preceding line. It is further determined whether pixel data corresponding to the current line to be outputted from the channels are substantially different from pixel data of the preceding line, if it is determined that the current line is not polarity inverted from the preceding line. Charge sharing is performed in groups if it is determined that the current line and the preceding line are substantially different; otherwise, no charge sharing is performed.

### BRIEF DESCRIPTION OF THE DRAWINGS

FIG. 1A through FIG. 1C show exemplary polarity inversion types for an LCD panel;

FIG. 2 shows a flow diagram illustrating a method of dynamically charge sharing for an LCD panel according to one embodiment of the present invention;

FIG. 3 shows a 1+2 line inversion type for a stripe LCD panel having a pixel on/off pattern;

FIG. 4 shows a 1+2 line inversion type for a stripe LCD panel having a column on/off pattern; and

FIG. 5 shows a column inversion type for a zigzag LCD panel having a red pattern.

### DETAILED DESCRIPTION OF THE INVENTION

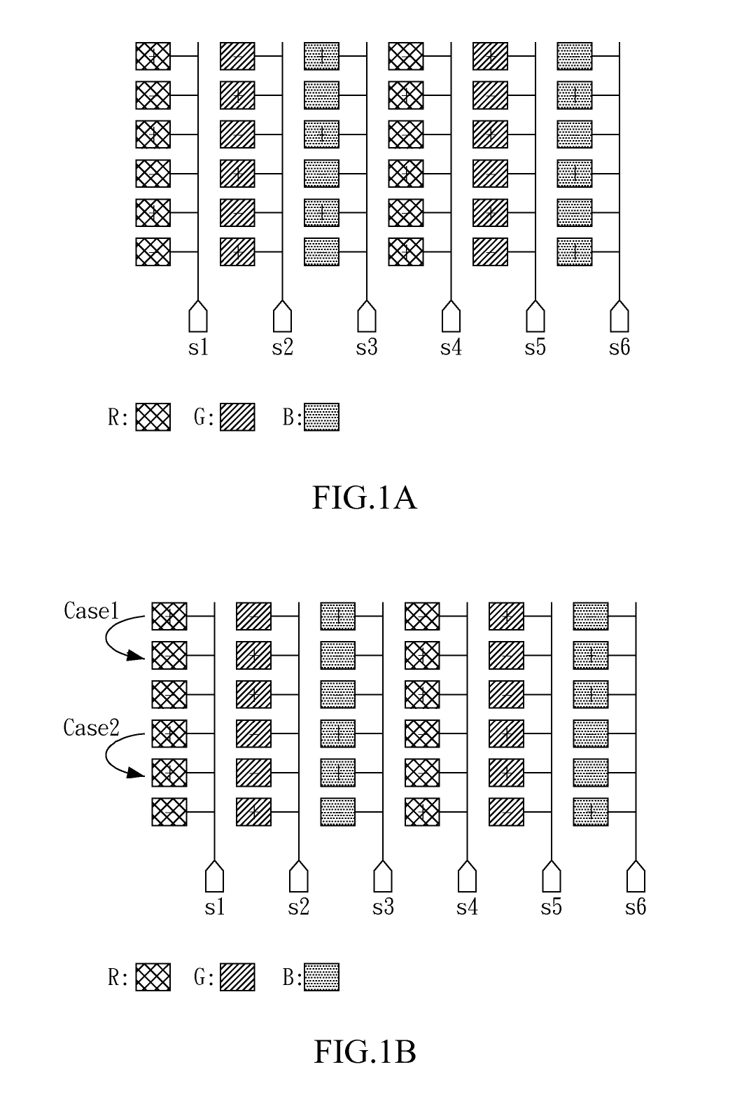

FIG. 1A through FIG. 1C show exemplary polarity inversion (“inversion” for short) types for a liquid crystal display (LCD) panel that will be adopted later in the embodiment of the present invention. FIG. 1A shows a dot inversion type for a stripe (LCD) panel, of which each channel (S1-S6) outputs pixel data associated with the same column (or “stripe”) successively. In the stripe panel of FIG. 1A, each pixel datum (or “dot”) has a polarity, designated as “+” or “−”, opposite to a neighboring pixel datum of the same line or same column.

FIG. 1B shows a 1+2 line inversion type for a stripe (LCD) panel. In the stripe panel of FIG. 1B, each pixel datum has a polarity opposite to a neighboring pixel datum of the same line, but not always has a polarity opposite to a neighboring pixel datum of the same column. As shown in FIG. 1B, for example, the first line and the second line (designated as case 1) have opposite polarities, and the fourth line and the fifth line (designated as case 2), however, have the same polarities. With respect to case 1, when charge sharing is performed in the stripe panel of FIG. 1B, less power is consumed than without charge sharing. However, with respect to case 2, more power, instead of less power, may be consumed sometimes than without charge sharing.

FIG. 1C shows a column inversion type for a zigzag (LCD) panel, of which each channel (S0-S6) outputs pixel data alternately associated with two adjacent columns. Accordingly, each channel (S0-S6) outputs pixel data having a polarity opposite to a neighboring channel. Similar to case 2 of FIG. 1B, when charge sharing is performed in the zigzag panel of FIG. 1C, more power, instead of less power, may be consumed sometimes than without charge sharing.

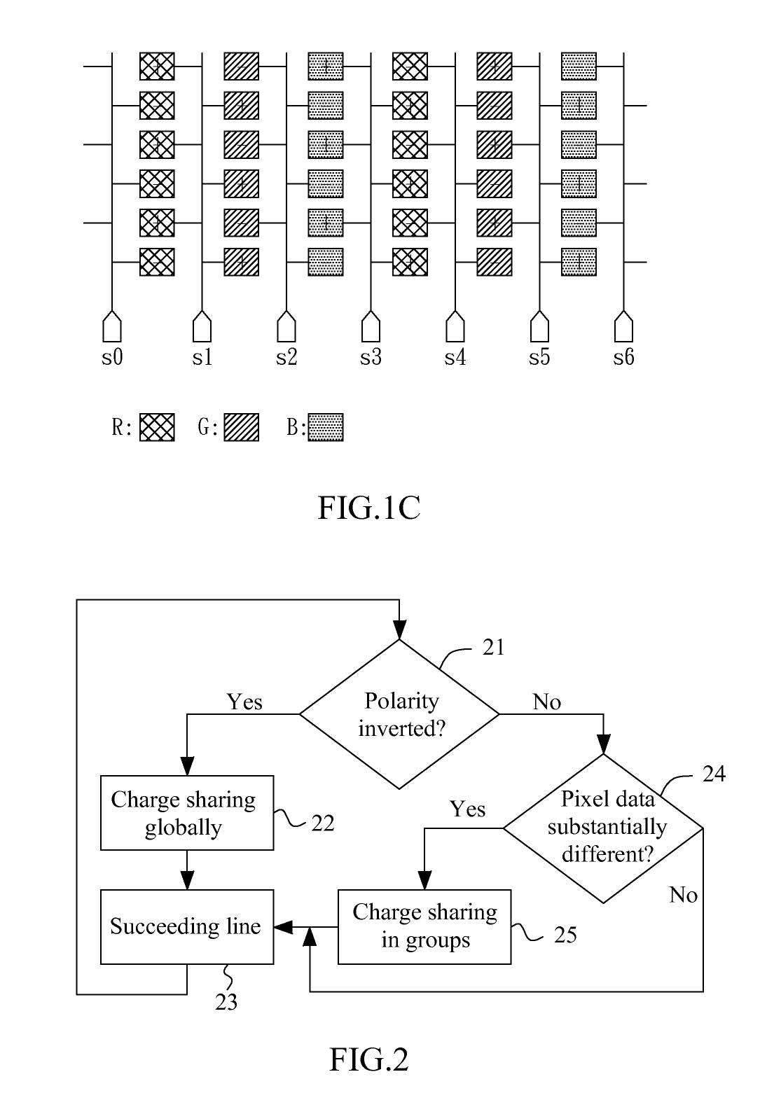

In order to improve performance of charge sharing performed in an LCD panel considering the exemplary polarity inversion types illustrated above, a method of dynamic charge sharing is disclosed as illustrated, in a flow diagram in FIG. 2. In step 21, it is determined whether pixel data corresponding to a current line to be outputted from channels of a data driver (such as a source driver) have polarity inverted from a preceding line outputted from the channels. If it is determined, in step 21, that the polarity is inverted (such as case 1 of FIG. 1B), charge sharing (step 22) is performed globally (i.e., for all channels), and the flow continues with a succeeding line (step 23).

If it is determined, in step 21, that the polarity is not inverted (such as case 2 of FIG. 1B), it is further determined, in step 24, whether pixel data corresponding to the current line to be outputted from the channels are substantially different from pixel data of the preceding line. In the embodiment, the pixel data of the current line and the preceding line are “substantially different” when a majority (i.e., more than half) of differences between the pixel data of the current line and the pixel data of the preceding line are greater than a predetermined threshold. In the embodiment, the difference between pixel data is decided in digital manner, for example, by comparing digital equivalents of the pixel data before they are converted to an analog form in the source driver. Take 6-bit system for example, two pixel data are substantially different when the difference therebetween is greater than 32 gray levels. Take 8-bit system for example, two pixel data are substantially different when the difference therebetween is greater than 64 gray levels.

According to another aspect of the embodiment, instead of determining pixel data of full channels, a partial amount (e.g., 1/10 or 1/100) of the channels of the source driver may be sampled, and the sampled pixel data are then determined in step 24. As a result, storage space for storing the pixel data to be compared may be greatly cut down, and speed may accordingly be reduced as well.

If it is determined, in step 24, that the pixel data corresponding to the current line to be outputted from the channels are substantially different from the pixel data of the preceding line, charge sharing (step 25) is performed in groups; otherwise, no charge sharing is performed and the flow continues with a succeeding line (step 23). In the embodiment, the charge sharing performed in step 25 is performed in two groups an odd group composed of odd-numbered channels and an even group composed of even-numbered channels. Take FIG. 1B as example, the odd group is composed of channels S1, S3 and S5; and the even group is composed of channels S2, S4 and S6.

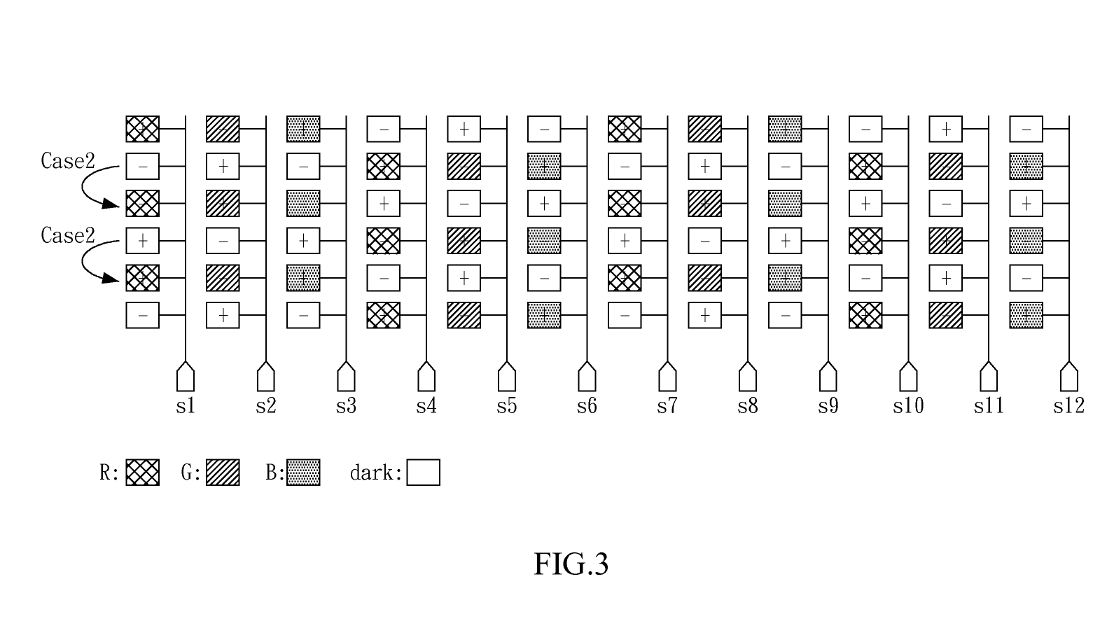

The performance of charge sharing performed in an LCD panel by the disclosed method of charge sharing may be profoundly appreciated with the following examples. FIG. 3 shows a 1+2 line inversion type for a stripe (LCD) panel having a pixel on/off pattern, that is, repeated bright red/green/blue (R/G/B) pixel data followed by dark R/G/B pixel data in the same line. With respect to case 2 designated in FIG. 3, it is determined, in step 24, that the pixel data between two lines are substantially different, and charge sharing (step 22) is thus performed. Quantitatively speaking, alternating-current (AC) current without charge sharing may, for example, be 20 mA, and AC current with charge sharing may be reduced to 15.56 mA (=20 mA/2+20 mA/2*(1/2)/0.9, where 1/2 represents an ideal voltage change, and 0.9 represents charge sharing efficiency).

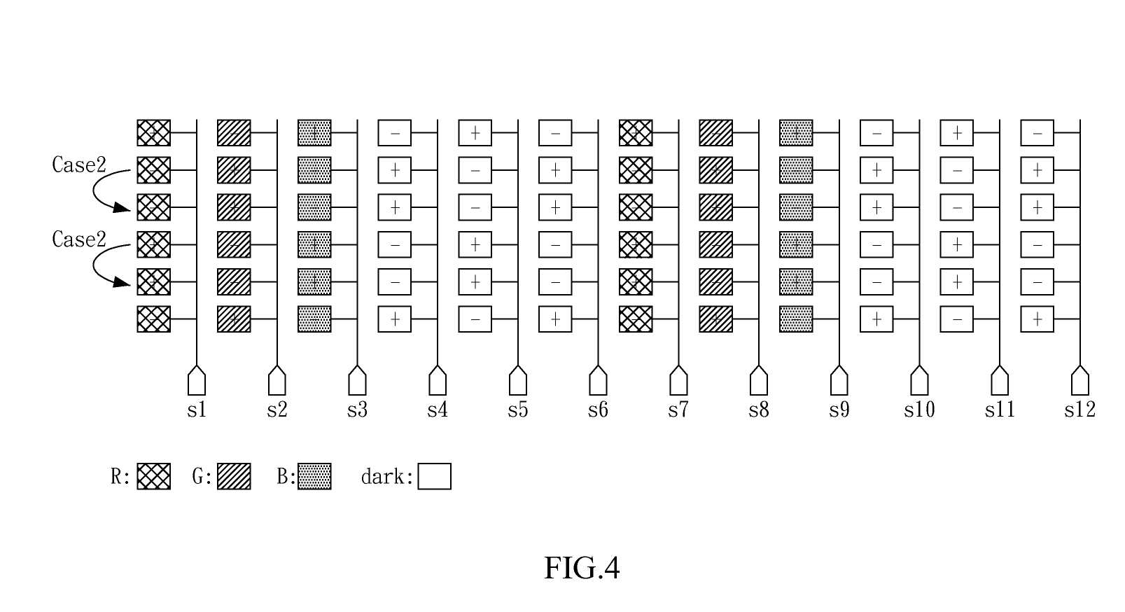

FIG. 4 shows a 1±2 line inversion type for a stripe (LCD) panel having a column on/off pattern, that is, repeated bright red/green/blue (R/G/B) column pixel data followed, by dark R/G/B column pixel data. With respect to case 2 designated in FIG. 4, it is determined, in step 24, that the pixel data between two lines are not substantially different, and charge sharing (step 22) is therefore not performed.

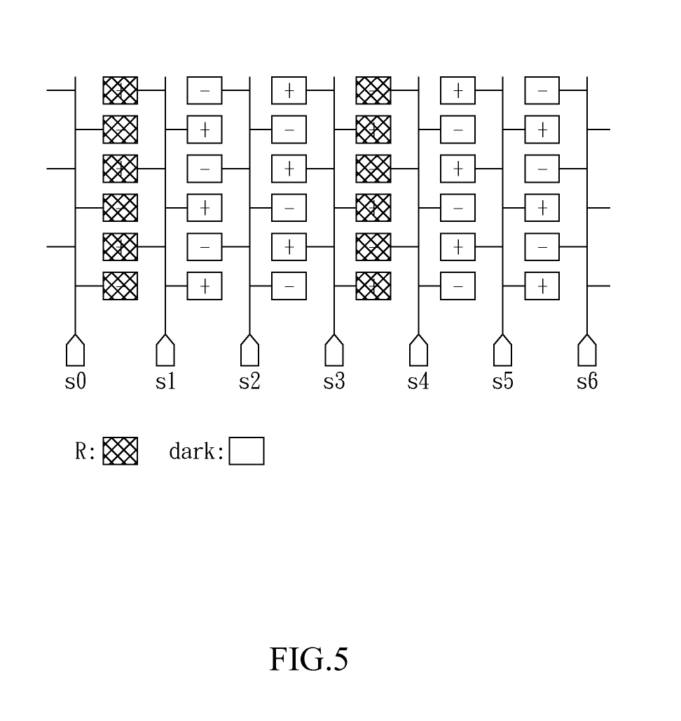

FIG. 5 shows a column inversion type for a zigzag (LCD) panel having a red pattern, that is, repeated bright red column pixel data followed by dark G and B column pixel data. It is determined, in step 24, that the pixel data between two lines to be outputted from the channels are substantially different, and charge sharing (step 22) is thus performed. Quantitatively speaking, alternating-current (AC) current without charge sharing may, for example, be 30 mA, and AC current with charge sharing may be reduced to 22.2 2mA (=30 mA*(2/3)/0.9, where 2/3 represents an ideal voltage change, and 0.9 represents charge sharing efficiency).

Although specific embodiments have been illustrated and described, it will be appreciated by those skilled in the art that various modifications may be made without departing from the scope of the present invention, which is intended to be limited solely by the appended claims.

What is claimed is:

1. A method of dynamic charge sharing for a display device, comprising:
determining whether pixel data corresponding to a current line to be outputted from channels of a data driver have polarity inverted from a preceding line outputted from the channels;
performing charge sharing globally for all the channels, if it is determined that the current line is polarity inverted from the preceding line;
determining whether pixel data corresponding to the current line to be outputted from the channels are substantially different from pixel data of the preceding line, if it is determined that the current line is not polarity inverted from the preceding line; and
performing charge sharing in groups, if it is determined that the current line and the preceding line are substantially different; otherwise, no charge sharing is performed.

2. The method of claim 1, wherein the display device comprises a liquid crystal display (LCD).

3. The method of claim 1, wherein the data driver comprises a source driver.

4. The method of claim 1, wherein the current line and the preceding line are substantially different when a majority of differences between the pixel data of the current line and the pixel data of the preceding line are greater than predetermined threshold.

5. The method of claim 4, wherein the difference between pixel data is decided in digital manner by comparing digital equivalents of the pixel data before they are converted to an analog form in the data driver.

6. The method of claim 4, wherein differences of full channels of the data source are compared to determine whether the current line and the preceding line are substantially different.

7. The method of claim 4, wherein differences of a partial amount of channels of the data source are compared to determine whether the current and the preceding line are substantially different. The method of claim 1, wherein the charge sharing is performed in groups including an odd group composed of odd-numbered channels of the data driver and an even group composed of even-numbered channels of the data driver.
